(19) United States
(12) Patent Application Publication
(10) Pub. No.: US 2013/0120991 A1
(43) Pub. Date: May 16, 2013

(54) LIGHTING MODULE FOR ILLUMINATING TRAFFIC ROUTES, AND TRAFFIC ROUTE LUMINAIRE

(71) Applicants: Ernst Wohlgemuth, Cortaccia/Kurtatsch (BZ) (IT); Andreas Timinger, Cortaccia/Kurtatsch (BZ) (IT)

(72) Inventors: Ernst Wohlgemuth, Cortaccia/Kurtatsch (BZ) (IT); Andreas Timinger, Cortaccia/Kurtatsch (BZ) (IT)

(73) Assignee: ewo srl/GmbH, Cortaccia/ Kurtatsch (IT)

(21) Appl. No.: 13/578,178

(22) PCT Filed: Feb. 10, 2011
(86) PCT No.: PCT/EP2011/051945

§ 371 Date: Jan. 28, 2013

(30) Foreign Application Priority Data
Feb. 11, 2010 (DE) 10 2010 001 860.0

(51) Int. Cl. F21V 13/04

(52) U.S. Cl. CPC F21V 13/04
USPC 362/246

(57) ABSTRACT

A lighting module for the stationary illumination of traffic routes comprises a plurality of light-emitting diodes and a light-shaping element. The light-shaping element comprises a plurality of refractive optical free-form surfaces for shaping light and at least one light-scattering area, which is configured to radiate, during the operation of the lighting module, diffused light originating from the light-emitting diodes. A traffic route luminaire comprises a housing and a plurality of lighting modules that are disposed in such a way in the housing that the longitudinal axes of the lighting modules extend next to each other and parallel to each other and the light-radiating faces of the lighting modules are disposed in a sawtooth shape relative to one another. The design according to the invention on the one hand enables a good illumination of the traffic route area and, on the other hand, prevents glare or disturbance to passers-by or residents.

### FIELD OF THE INVENTION

The invention generally relates to the technical field of traffic route illumination. More specifically, the invention relates to a lighting module for the stationary illumination of traffic routes as well as to a traffic route luminaire in which light-emitting diodes serve as light sources. In the terminology of the present document, a “traffic route” is to be understood to mean all public or private traffic areas, i.e., for example, roads, bicycle and pedestrian paths, pedestrian zones, railway tracks, public and private spaces visited by the public, etc.

### BACKGROUND OF THE INVENTION

Lighting modules and traffic route luminaires comprising light-emitting diodes are known as such. For example, WO 2008/137172 A1 shows a lighting module for a traffic route luminaire. The lighting module comprises a plurality of light-emitting diodes, each of which is associated with a light-shaping element having a refractive optical free-form surface for shaping light.

There is a possibility in the aforementioned luminaire of people being dazzled if they look at the luminaire from below and see the individual light-emitting diodes—through the light-shaping elements—as glaringly bright spots. Therefore, a luminaire design would be desirable which reduces the glare for passers-by and other traffic.

An outdoor LED lamp with several lighting modules, which is provided for assembly at an oblique angle to the road surface, is known from EP 1 916 468 A1. In this case, there is a risk of undesired scattered light directed upwards, which could dazzle or at least disturb residents. It would be desirable to reduce or completely avoid such scattered light which is directed in an upward direction (i.e. with an emission angle of greater than 90° relative to a vertical downward direction).

### SUMMARY OF THE INVENTION

The invention generally has the object of proposing a lighting module for traffic route illumination and a traffic route luminaire which, on the one hand, enable a good illumination of the traffic route area and, on the other hand, prevent glare or disturbance to passers-by or residents.

The invention is defined by the independent claims. The dependent claims relate to optional features of embodiments of the invention.

A first aspect of the invention is based on the basic concept of using a light-shaping element comprising a plurality of refractive optical free-form surfaces for shaping light and at least one light-scattering area in the surroundings of the free-form surfaces. The light-scattering area is configured to emit diffused light during the operation of the lighting module. Due to this surrounding area of diffused light, a possible glare of the light component exiting the free-form surfaces in a concentrated manner is reduced or avoided.

The effect of the additional diffused light for reducing the glare is particularly pronounced if—as is provided in some embodiments—the light-shaping element in the area of each free-form surface is configured to be clear and if no further scattering element is provided in this area in the lighting module or the traffic route luminaire.

Preferably, each free-form surface is provided for achieving a desired emission pattern—generally prescribed by the pertinent standards—for the useful light emitted by the lighting module. In some embodiments a particularly exact shaping of light is achieved by relatively large free-form surfaces being used, each of which, for instance, has a surface area of at least 5 cm² or at least 7.5 cm² or at least 10 cm². This is advantageous particularly in connection with LED lamps, because having to overdesign the light sources in order to compensate for light distribution errors would cause high costs.

In some embodiments, not only a single light-emitting diode, but an array of a plurality of light-emitting diodes, is provided for each free-form surface. In this way, the light flux through each free-form surface can be increased so that fewer of the relatively complex free-form surfaces are required in order to obtain a desired total light output. In embodiments which employ the light-emitting diode arrays, the feature of the light-shaping element comprising at least one light-scattering area in the vicinity of the free-form surfaces is considered an optional feature, which is advantageous but not an absolute requirement.

According to a second aspect of the invention, a lighting module for the stationary illumination of traffic routes is provided. The lighting module comprises a plurality of light-emitting diodes and a light-shaping element. The light-shaping element comprises a plurality of refractive optical free-form surfaces for shaping light. At least some of the free-form surfaces are each associated with a respective array of light-emitting diodes of the light-emitting diodes, each array of light-emitting diodes consisting of three light-emitting diodes disposed at the corners of an isoceles triangle.

In embodiments which employ the light-emitting diode arrays, the light-emitting diodes of each array can, for example, be disposed mirror-symmetrically with respect to, in each case, exactly one plane. For example, the light-emitting diodes of an array are disposed in some embodiments at the corners of an isoceles—but not equilateral—triangle. The free-form surfaces can also be configured to be mirror-symmetrical to, in each case, exactly one mirror plane, wherein in some embodiments this plane of symmetry of a free-form surface corresponds to the plane of symmetry of the associated light-emitting diode array.

In some embodiments the light-shaping element comprises a light-entrance face and a light-radiating face. Here, the term “face” does not necessarily mean a straight or smooth surface. In particular, the—curved—free-form surfaces can be incorporated into the light-radiating face or the light-entrance face or into both.

A third aspect of the invention is based an the basic concept of disposing, in a traffic route luminaire with a housing and a plurality of lighting modules, the lighting modules side-by-side in the housing, inclined in a uniform direction in such a way that the light-emitting faces of the lighting modules are disposed in a sawtooth shape relative to one another. This embodiment creates the technical basis for a traffic route luminaire which, with a relatively simple optical structure, has a main radiating direction extending obliquely to the housing. Such a traffic route luminaire can be provided, for example, for assembly in the horizontal direction—approximately parallel to a plane of the road. In this way, disturbing scattered light can be shielded with little constructional effort.

In some embodiments the lighting modules of the traffic route luminaire according to the second aspect of the invention are designed like the above-described lighting modules according to the first aspect. In that case, the lighting modules comprise features and combinations of features as they are described above and/or were defined in the claims relating to the lighting module. However, the feature of a light-scattering area of the light-shaping element is in this case considered an optional feature which is provided in some, but not all, embodiments. In further alternatives, instead of a single light-shaping element with a plurality of free-form surfaces, a plurality of light-shaping elements with at least one free-form surface each can also be provided in such lighting modules.

In some embodiments the lighting modules are arranged side-by-side in the housing along an arrangement axis, and light-radiating axes of the lighting modules extend approximately parallel to one another, but obliquely to the arrangement axis. The angle between the light-radiating axes of the lighting modules and the arrangement axis is fixed by the structural shape. In some embodiments this angle can be, for example, between 45° to 135°, or between 60° to 120°, with the perpendicular angle of 90° in each case being excluded.

A particularly economical embodiment of the traffic route luminaire results from the use of identical lighting modules.

### BRIEF DESCRIPTION OF THE DRAWINGS

Other features, advantages and objects of the invention become apparent from the attached schematic drawings of several exemplary embodiments. In the figures:

FIG. 1 shows an exploded view of a lighting module according to a first exemplary embodiment,

FIG. 2 shows a perspective view of the lighting module of FIG. 1,

FIG. 3 shows a top view onto the lighting module of FIG. 1, with the light-shaping element facing towards the observer,

FIG. 4 shows a side view of the lighting module of FIG. 1,

FIG. 5 shows a longitudinal section through a traffic route luminaire according to a second exemplary embodiment comprising a plurality of lighting modules in a housing, and

FIG. 6 shows a perspective view of the traffic route luminaire of FIG. 5.

### DETAILED DESCRIPTION OF EMBODIMENTS OF THE INVENTION

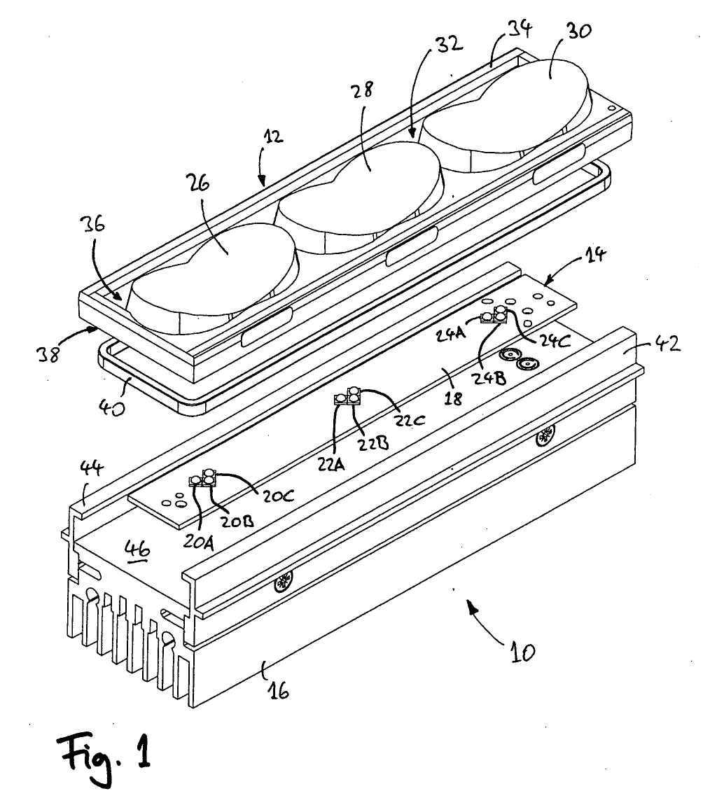

The lighting module 10 shown in FIG. 1 has as its main components a light-shaping element 12, a light-emitting diode unit 14 and a cooling body 16 which serves as a base. The light-emitting diode unit comprises a circuit board 18 and several light-emitting diodes 20A, 20B, 20C, 22A, 22B, 22C, 24A, 24B, 24C. The light-emitting diodes 20A-24C in the present exemplary embodiment are divided into arrays of three, namely into a first array with the three light-emitting diodes 20A, 20B, 20C, a second array with the three light-emitting diodes 22A, 22B, 22C and a third array with the three light-emitting diodes 24A, 24B, 24C. In the following, these arrays are together referred to as 20x, 22x, 24x.

The light-shaping element 12 comprises several—in the present exemplary embodiment three—refractive optical free-form surfaces 26, 28, 30. In this case, the first free-form surface 26 is optically associated with the first light-emitting diode array 20x in the sense that the light emitted by the light-emitting diode array 20x passes through the light-shaping element 12 largely in the area of the first free-form surface 26. Thus, the first free-form surface 26 serves for shaping the light for a predominant part of the light that is radiated by the first light-emitting diode array 20x in the direction towards the light-shaping element 12. Correspondingly, the second free-form surface 28 is associated with the second light-emitting diode array 22x, and the third free-form surface 30 is associated with the third light-emitting diode array 24x. By combining, in each case, several light-emitting diodes into one array 20x, 22x, 24x, respectively, the achievable light flux through each free-form surface 26, 28, 30 is increased without discernibly degrading the light-shaping properties of the free-form surfaces 26, 28, 30.

On the whole, the light of the respectively associated light-emitting diode array 20x, 22x, 24x is shaped in accordance with the desired emission pattern by the refractive optical configuration of each free-form surface 26, 28, 30. Depending on the arrangement and installation position of the lighting modules 10 in a traffic route luminaire, this emission pattern aims at achieving an overall light distribution of the traffic route luminaire that is predetermined by the pertinent standards. By using free-form surfaces instead of conventional spherical or aspherical lenses in the light-shaping element 12, the desired emission pattern can be accomplished in a very precise manner and with only little loss of light. This particularly applies to the relatively large free-form surfaces 26, 28, 30 of the present exemplary embodiments, each of which, for example, have an optically effective surface area of at least 5 cm².

In the present exemplary embodiments, the light-shaping element 12 in the area of the free-form surfaces 26, 28, 30 is configured to be clear in order to enable a shaping of the light with maximum accuracy. In contrast, the light-shaping element 12 has a light-scattering area 32 between the free-form surfaces 26, 28, 30, which during the operation of the lighting module 10 emits diffused light. In the exemplary embodiment described here, the light-scattering area 32 takes up the entire available surface between the free-form surfaces 26, 28, 30 and an outer frame 34 of the light-shaping element 12, with the free-form surfaces 26, 28, 30, however, being directly adjacent to the frame 34—i.e., without a light-scattering area 32. In particular, the light-scattering area 32 in the exemplary embodiment shown here extends in an uninterrupted manner between two free-form surfaces 26, 28, or 28, 30, respectively. In the light-scattering area 32, the light-shaping element 12 can, for example, be configured to be milky or have a light-scattering coating or a light-scattering surface treatment.

During the operation of the lighting module 10 a certain proportion of the light radiated by the light-emitting diode arrays 20x, 22x, 24x penetrates the light-shaping element 12 in the light-scattering area 32. This causes the background surrounding the free-form surfaces 26, 28, 30 to appear bright to an observer. A glare due to the almost point-shaped, bright light-emitting diodes 20A-24C, which are visible through the clear free-form surfaces 26, 28, 30, is thereby reduced or avoided.

In the exemplary embodiment described here, the free-form surfaces 26, 28, 30 are formed on a light-radiating face 36 of the light-shaping element 12, whereas the light of the light-emitting diodes 20x, 22x, 24x enters the light-shaping element 12 at a light-entrance face 38. It is clear that in alternative embodiments, the free-form surfaces 26, 28, 30 can be formed exclusively or additionally on the light-entrance face 38, or that additional optically effective surfaces (not necessarily free-form surfaces) can be provided on the light-entrance face 38. Moreover, a light-scattering coating or surface treatment can be provided in the light-scattering area 32 on the light-radiating face 36, the light-entrance face 38 or on both faces.

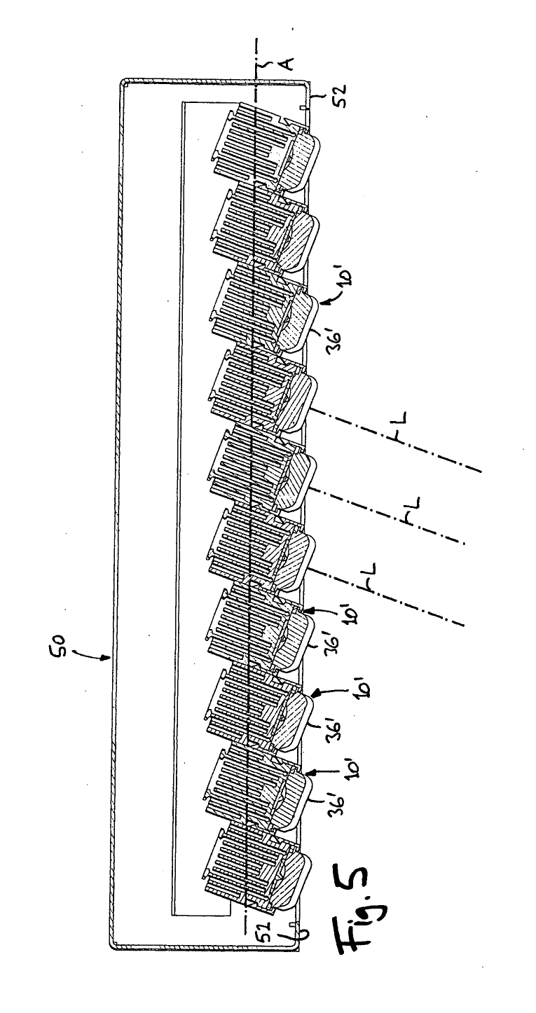

Each free-form surface 26, 28, 30 has the shape of a butterfly in the exemplary embodiment described here. As is apparent in particular from FIG. 3, each free-form surface 26, 28, 30 is configured to be mirror-symmetrical to a transverse axis Q1 of the free-form surface 26, 28, 30. However, there is neither a mirror symmetry nor a rotational symmetry relative to a longitudinal axis L1 of the free-form surface 26, 28, 30. This is also clearly apparent from FIG. 4, in which the longitudinal axis L1 extends perpendicularly to the plane of the drawing.

Therefore, the arrangement of the light-emitting diodes 20A-24C in the light-emitting diode arrays 20x, 22x, 24x corresponds to the configuration of the respectively associated free-form surfaces 26, 28, 30 inasmuch as the light-emitting diodes 20A-24C of each array 20x, 22x, 24x are also disposed mirror-symmetrically to a transverse axis Q2 of this array; in the exemplary embodiment shown here, the transverse axis Q2 of each light-emitting diode array 20x, 22x, 24x coincides with the transverse axis Q1 of the associated free-form surface 26, 28, 30. However, there is neither a mirror symmetry nor a rotational symmetry in the direction of a longitudinal axis L2 extending through each light-emitting diode array 20x, 22x, 24x in the longitudinal direction of the associated free-form surface 26, 28, 30. In the present exemplary embodiment, the light-emitting diodes of each array 20x, 22x, 24x are disposed at the corners of an imaginary isoceles triangle, the basis of which extends parallel to the axis L2 and the two legs of which extend mirror-symmetrically to the axis Q2.

As is apparent from FIG. 1, a gasket 40, which ensures a dust-proof and liquid-tight seal, is disposed between the light-shaping element 12 and the cooling body 16 serving as a base. The light-shaping element 12 is fixed to the cooling body 16 by means of two lateral mounting rails 42, 44, with the frame 34 of the light-shaping element 12 resting on a mounting surface 46 of the cooling body 16. The light-emitting diode unit 14 is also connected to the mounting surface 46 in order to ensure a good dissipation of the heat from the light-emitting diodes 20A-24C into the cooling body 16. Between the light-emitting diodes 20A-24C and the light-entrance face 38 of the light-shaping element 12, there is a certain intermediate space dimensioned such that, on the one hand, a large part of the light emitted by each light-emitting diode array 20x, 22x, 24x is radiated into the area of the respectively associated free-form surface 26, 28, 30, and, on the other hand, that a sufficient part of the light arrives at the light-scattering area 32 and is there emitted as diffused background light.

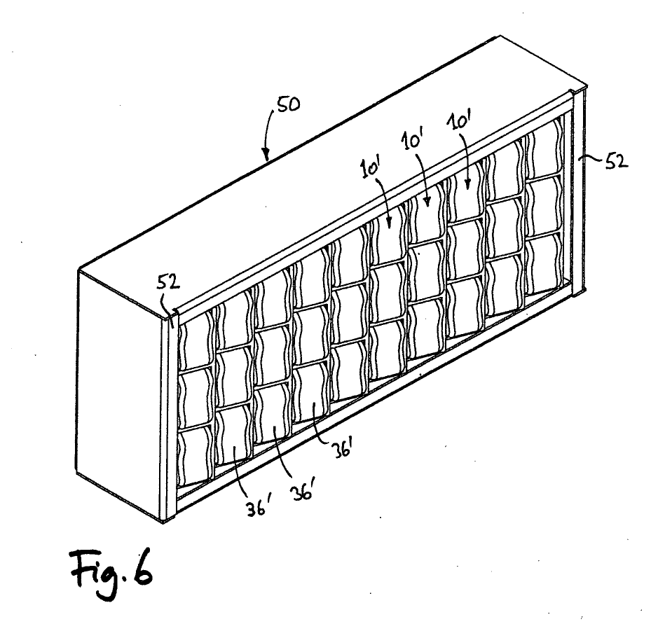

FIGS. 5 and 6 show an exemplary embodiment of a traffic route luminaire in which several lighting modules 10′ with one light-radiating face 36′ each are inserted into a housing 50. For example, the housing 50 is configured in the approximate shape of a rectangular parallelepiped and comprises lower edges 52 that enclose an installation opening for the lighting modules 10′.

The lighting modules 10′ shown in FIGS. 5 and 6 differ from the lighting modules 10 described so far. Just like the lighting modules 10, however, the lighting modules 10′ also comprise several light-emitting diodes and several refractive optical free-form surfaces for shaping light. In some—but not all—exemplary embodiments, the free-form surfaces of the lighting modules 10′ are configured just like the above-described free-form surfaces 26, 28, 30 of the lighting modules 10. In optional developments of such embodiments, each one of such free-form surfaces can moreover be associated with one array, respectively, of light-emitting diodes, which, for example, can be configured and arranged just like the light-emitting diode array 20x, 22x, 24x described above.

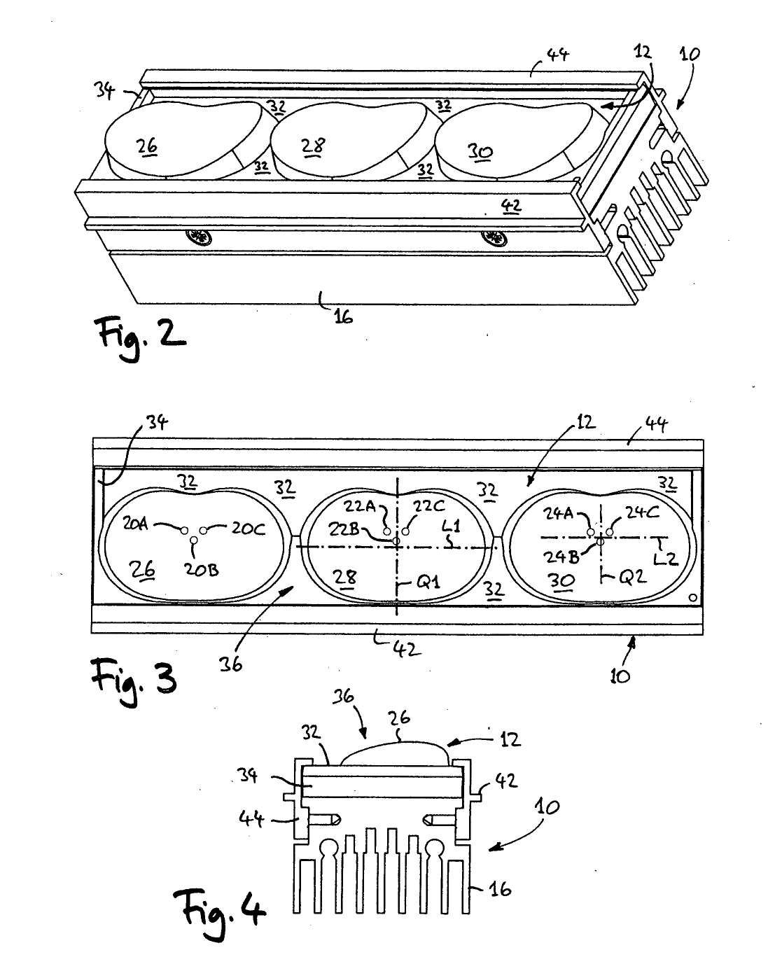

In other alternative embodiments, the traffic route luminaire according to FIGS. 5 and 6 is modified by lighting modules 10, as they are shown in FIGS. 1 to 4 and described in detail above, being provided instead of the lighting modules 10′.

What the exemplary embodiment shown in FIGS. 5 and 6 and all modifications mentioned above have in common is that the lighting modules 10, 10′ are disposed side-by-side in the housing in such a way that the longitudinal axes of the lighting modules 10, 10′—in FIG. 5, perpendicular to the plane of the drawing—extend next to each other and parallel to each other. FIG. 5 shows an arrangement axis A along which the lighting module 10, 10′ are placed in a row.

Each of the lighting modules 10, 10′ has a light-radiating axis L which is characteristic for the primary light-radiating direction of the lighting module 10, 10′. In the exemplary embodiments of the traffic route luminaire described here, the light-radiating axes L of the lighting modules 10, 10′ extend parallel to one another, but obliquely to the arrangement axis A. In this case, there is a fixed angle between the light-radiating axes L and the arrangement axis which, for example, is between 45° and 85° or between 95° and 135°—depending on the quadrant in which the angle is measured. This means that the primary light-radiating direction of the arrangement shown in FIG. 5 has a component which, in the plane of the drawing, is predominantly, but not exclusively, directed in the downward direction.

On the whole, the arrangement of the lighting modules 10, 10′ in the luminaire 50 described here results in the light-radiating faces 36, 36′ of the lighting modules 10, 10′ extending in an approximate sawtooth shape relative to each other. This arrangement is advantageous in that an oblique light-radiating direction of the traffic route luminaire relative to the housing 50 can be obtained with little effort. In that case, the housing 50 can be disposed relatively close to the roadside and horizontally—i.e. parallel to the road surface. The lower edges 52 of the housing 50 in this case act as screens that reliably prevent an undesired upward emission of scattered light.

The details mentioned in the above description and shown in the drawings are not to be considered a limitation of the scope of the invention, but examples of embodiments of the invention. Other modifications are immediately apparent to the person skilled in the art. For example, features of the above-described embodiments may, for example, be combined with one another in order to obtain further embodiments of the invention. Accordingly, the scope of the invention is to be defined not by the above-described exemplary embodiments, but by the claims^{.}and their equivalents.

1. A lighting module for the stationary illumination of traffic routes, comprising a plurality of light-emitting diodes and a light-shaping element, wherein:
the light-shaping element comprises a plurality of refractive optical free-form surfaces for shaping light, wherein each free-form surface is associated with at least one of the light-emitting diodes, respectively, and
the light-shaping element further comprises at least one light-scattering area in the surroundings of the free-form surfaces, which is configured to radiate, during the operation of the lighting module, diffuse light originating from the light-emitting diodes.

2. The lighting module according to claim 1, wherein the light-shaping element in the area of each free-form surface is configured to be clear.

3. The lighting module according to claim 1, wherein each free-form surface is configured to emit, with a predefined emission pattern, light originating from the at least one associated light-emitting diode during the operation of the lighting module.

4. The lighting module according to claim 1, wherein the light-scattering area extends in an uninterrupted manner at least between two of the free-form surfaces .

5. The lighting module according to claim 1, wherein each free-form surface is associated with an array of light-emitting diodes, respectively.

6. The A lighting module for the stationary illumination of traffic routes, comprising a plurality of light-emitting diodes and a light-shaping element, wherein:
the light-shaping element comprises a plurality of refractive optical free-form surfaces for shaping light, wherein at least some of the free-form surfaces are each associated with a respective array of light-emitting diodes, each array of light-emitting diodes consists consisting of three light-emitting diodes disposed at the corners of an isoceles triangle.

7. The lighting module according to claim 6, wherein each free-form surface has an elongate shape with a longitudinal axis and a transverse axis and is configured mirror-symmetrical to the transverse axis, but not mirror-symmetrical to the longitudinal axis.

8. The lighting module according to claim 7, wherein, for each free-form surface, the array of light-emitting diodes associated with this free-form surface is disposed mirror-symmetrical to an axis extending through this array in the transverse direction of the free-form surface, but not mirror-symmetrical to an axis extending through this array in the longitudinal direction of the free-form surface.

9. The lighting module according to claim 1, wherein the light-shaping element comprises a light-entrance face and a light-radiating face, and wherein the light-emitting diodes and the light-shaping element are disposed in such a way that light emitted by the light-emitting diodes enters the light-entrance face of the light-shaping element and exits from the light-radiating face.

10. The lighting module according to claim 9, wherein the free-form surfaces are formed on the light-radiating face of the light-shaping element.

11. The lighting module (10) according to a claim 1, wherein each free-form surface has a surface area of at least 5 cm² .

12. (canceled)

13. A traffic route luminaire comprising a housing and a plurality of lighting modules, wherein each lighting module comprises a plurality of light-emitting diodes, a plurality of refractive optical free-form surfaces for shaping light, and a light-radiating face which is elongated in the direction of a longitudinal axis of the lighting module, and wherein the lighting modules are disposed in such a way in the housing that the longitudinal axes of the lighting modules extend next to each other and parallel to each other and the light-radiating faces of the lighting modules are disposed in a sawtooth shape relative to one another.

14. The traffic route luminaire according to claim 13, wherein the lighting modules are arranged side-by-side along an arrangement axis, and wherein each lighting module has a light-radiating axis, and wherein the light-radiating axes of the lighting modules extend approximately parallel to one another, but obliquely to the arrangement axis.

15. The traffic route luminaire according to claim 13 wherein the angle between the light-radiating axes of the lighting modules and the arrangement axis is between 45° and 85° or between 95° and 135°.

16. The traffic route luminaire according to claim 13, wherein, in each lighting module the plurality of refractive optical free-form surfaces are formed in the light-radiating face of the lighting module.

17. The traffic route luminaire according to claim 13, wherein the lighting modules are configured identically.

18. The traffic route luminaire according to claim 13, wherein at least one of the lighting modules comprises a plurality of light-emitting diodes and a light-shaping element, wherein:
the light-shaping element comprises a plurality of refractive optical free-form surfaces for shaping light, wherein each free-form surface is associated with an array of light-emitting diodes, respectively,
each free-form surface has an elongate shape with a longitudinal axis and a transverse axis and is configured mirror-symmetrical to the transverse axis, but not mirror-symmetrical to the longitudinal axis, and
for each free-form surface, the array of light-emitting diodes associated with this free-form surface is disposed mirror-symmetrical to an axis extending through this array in the transverse direction of the free-form surface, but not mirror-symmetrical to an axis extending through this array in the longitudinal direction of the free-form surface.

19. The traffic route luminaire according to claim 13, wherein the housing is intended for horizontal assembly and/or for assembly approximately parallel to a plane of the road.

20. The traffic route luminaire according to claim 13, wherein lower edges of the housing act as screens that prevent an undesired upward emission of scattered light.

21. The lighting module according to claim 6, wherein each free-form surface has a surface area of at least 7.5 cm².
